(19) United States
(12) Patent Application Publication
(10) Pub. No.: US 2016/0242383 A1
(43) Pub. Date: Aug. 25, 2016

(54) Animal Stirring Device

(71) Applicant: Paul T. Baker, JR., Millsboro, DE (US)

(72) Inventor: Paul T. Baker, JR., Millsboro, DE (US)

(73) Assignee: PAUL TERRANCE BAKER JR., Millsboro, DE (US)

(21) Appl. No.: 14/627,524

(22) Filed: Feb. 20, 2015

(51) Int. Cl. A01K 1/00; A01K 45/00

(52) U.S. Cl. CPC A01K 1/00; A01K 45/00

(57) ABSTRACT

An animal stirring device is used to stir animals, thus preventing them from remaining stagnant in their CAFO (Confined Animal Feed Operation) environments. The stirring device is comprised of a large number of durable lightweight material strips stitched together in a very unique way, with a small mounting hoop at the top. The stirring device can be delivered in several ways which have proven to be very efficient, one method is to use a pulley or track system which goes all around the CAFO. The stirring device is suspended by the mounting hoop, with it freely hanging vertically down. The motion of the conveyance system's movements and air cause the material to flutter giving the appearance of a larger animal coming through the CAFO, making it a must for the animals to get up and move. In another delivery method, the material strips, are attached to a pole at the top. A person walks around the CAFO with this in his hand, gently shaking it back and forth, once again giving the appearance of a larger animal coming through the house causing the animals to get up move out of the way thus preventing them from remaining stagnant and granting easier access to food for hungry animals.

### FIELD OF THE INVENTION

The present invention relates generally to devices for stirring stagnant animals in a CAFO (Confined Animal Feeding Operation) and more particularly moving recently fed lethargic animals away from food and water so other animals can be granted easy access.

### BACKGROUND OF THE INVENTION

In the commercial rearing of animals in CAFOs the animals are made so comfortable they have a tendency not to want to get up unless absolutely necessary which causes health issues for several reasons not only affecting those birds but also effecting large segments of the crop. In the past, the industry has tried light spiking; the practice of turning the light up dramatically to cause the animals to briefly get up and move around, or even changes to the environment in which the animals are living with limited success. Nowadays, with all the environmental controls available as well as organizations fighting for animal care and safety greater comfort is available to animals raised in the CAFO houses than ever before resulting better animal health but more animals in the same amount of space, resulting in a greater need for this device than ever before.

Similarly, as mentioned above, the light spiking method has not been efficient. Affluent farmers have been purchasing better quality of light devices in the past few years but have soon realized that not only do these devices represent an expensive capital investment, but the animals soon become accustomed to the periodic light. The shooting method however has worked the other way round. Instead of causing slight panic, it has been a source of anxiety and additional stress for the animals and this has proved to be very unprofitable, causing losses of up to 50 percent on the yields.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The animal stirring device of the present invention provides an inexpensive and reliable motion actuated animal stirring which can be used with various methods of delivery to prevent CAFO animals from remaining stagnant or having limited access to food and water. In one embodiment, the apparatus is comprised of strips of light weight durable material, stitched together with a hoop at the top which can be mounted to several delivery methods including a pole or an automated conveyance system, with the strips of material hanging vertically down, such that these may be caused to move in all directions by air movements which has been found to be very representative of a larger birds (in this case) and therefore effective at causing the animals to stir. Slight air movements produce a fluttering of the strips of material which draws attention when moving through the CAFO.

At the same time, the material strips should be made to look rather intimidating, but not frightening. The material strips should not be of the same lengths so as upon contact with the wind, these can move in all directions and seem like a larger animal making its way through the CAFO. The device is often most effective when elevated slightly above the height of the average animals in the CAFO and a large number of material strips is used to make the finishing device look big, even bigger than the normal size of an animal (refer to FIG. 2). The top of the hoop and the mounting device or attaching section is bolted through the animal stirring device itself, ensuring adherence to the delivery system. This will serve as a strong support for the material strips, and simultaneously insure that the movement and structure of the device will not be inhibited while coming in contact with anything inside the building, in case the first method is being used, that is the moving rod as the device will be going around the CAFO and is most likely to hit against walls or other obstacles.

In a farming environment, the animal stirring device should always be above the height of the average animal, irrespective of the delivery method being used. Otherwise, the animals will not be intimidated by the device and the desired goal will not be achieved. The height of the device above the average animal may also be adjusted depending where a group of animals are, and also in order to make it clearly visible to animals which are closer together, thus causing them to disperse

To the accomplishment of the foregoing and related ends, certain illustrative aspects of the disclosed invention are described herein in connection with the following description and the annexed drawings. These aspects are indicative of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

In order to describe the manner in which features and other aspects of the present disclosure can be obtained, a more particular description of certain subject matter will be rendered by reference to specific embodiments that arc illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1A is a front semi-diagrammatic view of an animal stirring device;

FIG. 1B illustrates a perspective view of the animal stirring device mounted to a pole in accordance with an embodiment of the present invention;

FIG. 2 is a side view of the animal stirring device mounted to a pole being handled manually by a person;

FIG. 3A is a top view of the arrangement of an automated delivery system known in the art which is being used in conjunction with the animal stirring device of the present invention; and

FIG. 3B illustrates how the animal stirring device of the present invention will be travelling after being mounted to the automated delivery system.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In the commercial rearing of animals in CAFOs (confined animal feeding operations) the animals are made so comfortable they have a tendency no to want to get up unless absolutely necessary which causes health issues for several reasons not only affecting those birds but also effecting large segments of the group.

The industry has tried light spiking; the practice of turning the light up dramatically to cause the animals to briefly get up and move around with limited success as this often causes excessive movement and calorie burn (low yields) with no assurance that the hungry animals will have better access to food and water.

A disease or infection can spread rapidly among stagnant birds because they are less healthy due to a degree of inactivity. They also share the same food and water bowls, which can spread disease and infections from sick to healthy birds. It must be kept in mind that animals are mostly hardy but their health can be reduced by inactivity, poor air quality, and reduced access to food and water.

Often after an animal has visited the feed and water area of the CAFO the animal becomes lethargic having just gorged themselves with feed. This animal will most often immediately sit down, rather than moving to give other animals access to the feed and water.

Hence the present invention, a simple object, which looks like a larger animal moving through the CAFO, this larger animal will cause the lethargic animals to get up and move out of the way for their own safety. Due to the low speed of the invention's movement little to no anxiety or additional stress is placed on the animals, they simply move in the opposite direction. The only thing that will consistently make the animals in a CAFO environment get up and move is a larger animal, but the farmer has to make sure that the simulation is moving slowly so as not to cause panic.

This invention offers innovative method of arousing and stirring commercially grown animals by taking advantage of the fouls natural tendencies. The regular stirring or dissemination of animals thought the CAFO without anxiety or extreme fluctuations in environmental conditions results in lower chronic health issues caused by inactivity, better access to food and water, and a net increase in weight gain by a larger percentage of the crop's population.

The animals being raised today for the meat industry have been genetically breaded to improve desired traits (larger yields and better feed conversion) while simultaneously eliminating undesirable traits. As a result the animals today have lost many of the survival instincts that have kept their species alive for millions of years, about the only thing CAFO animals are afraid of today are larger animals in the same CAFO environment; everyone gets out of their way.

A device caused to replicate a larger animal moving through the house encourage smaller animals to move out of the way to avoid harm, if the object is moving slowly this is done without causing anxiety and additional stress.

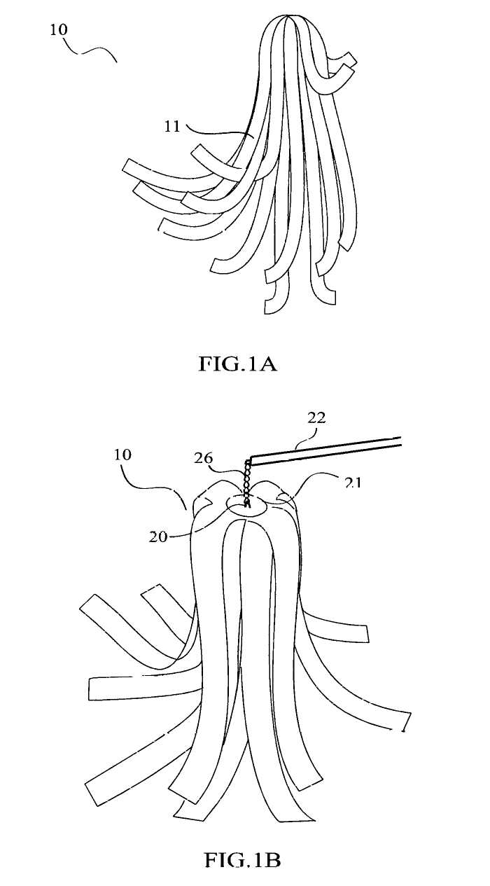

FIG. 1A illustrates a front semi-diagrammatic view of one embodiment of the animal stirring device 10 of the present invention, which comprises of a plurality of strips 11, a hoop 21 (not shown in FIG. 1A) and a mounting device 20 (not shown in FIG. 1). The plurality of strips 11 can be manufactured from any suitable light weight durable material known in the art. The plurality of strips 11 can also be manufactured in different lengths and widths and in a variety of sizes. The plurality of strips 11 are strongly stitched together.

FIG. 1B illustrates a perspective view of one embodiment of the animal stirring device 10 of the present invention, mounted to pole 22 having a clip 26. As best illustrated in FIG. 1B, one end of each of the plurality of strips 11 are joined together with a hoop 21. To join the plurality of strips 11, ends of the strips 11 are stitched together or are pasted together with glue or any binding agent or fused together by applying heat and pressure at one end with a hoop 21 at the top. The mounting device 20 is attached to the plurality of strips 11 with the hoop 21 at the top. The mounting device 20 extends outwardly from the top of the exterior surface of the plurality of strips 11, preferably from the middle of the hoop 21 as shown in FIG. 1B. The hoop 21 at the top may be integrally formed with the plurality of strips 11 or the hoop 21 at the top is subsequently attached to the top of the plurality of strips 11 or the hoop 21 and the plurality of strips 11 are attached together by any means commonly known in the art such as with mechanical fasteners, adhesive, glue or other binding agent. Mounting device 20 may also be stitched into exterior surface of the plurality of strips 11 and the hoop 21. In some other embodiments, the mounting device 20 is attached at the centre of the plurality of strips 11 at the top or at any other suitable position.

As best illustrated in FIG. 1B, the plurality of strips 11 of the animal stirring device 10 of the present invention hangs vertically down when the animal stiffing device 10 is mounted to a pole 22. The animal stirring device 10 is mounted to the pole 22 by attaching the mounting device 20 to the clip 26 of the pole 22. The plurality of strips 11 of the animal stirring device 10 moves in all direction by air movement. Slight air movement produces a fluttering of the plurality of strips 11.

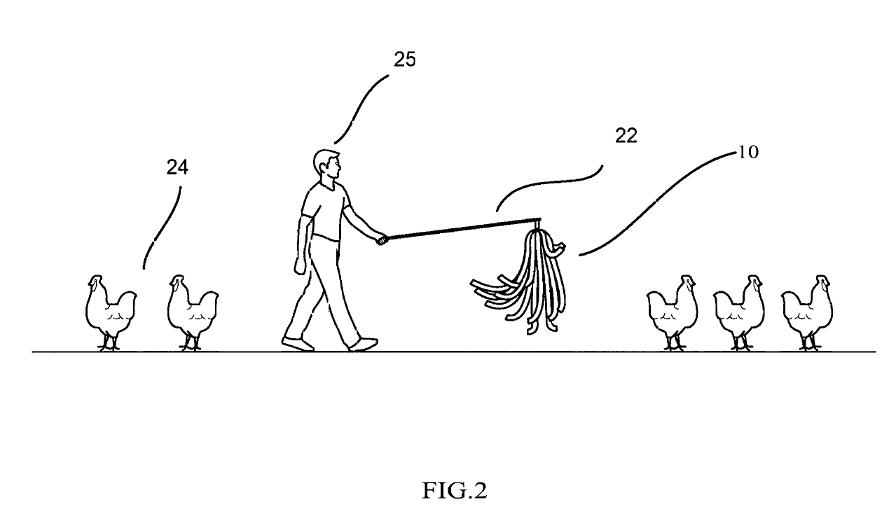

FIG. 2 illustrates a side view of the animal stirring device 10 mounted to a pole 22, the pole 22 being held by a person 25. As best illustrated in FIG. 2, in a preferred method of the present invention, the animal stirring device 10 can be used manually. The animal stirring device 10 is mounted to the pole 22 by attaching the mounting device 20 to the clip 26 of the pole 22. This act as a pivot to prevent the animal stirring device 10 from getting disrupted, for instance in case of strong air movements, with the pole 22 being held horizontally so as all the strips 11 hang vertically down. Person 25, in most cases the CAFO' s owner, walk towards the animals (birds in this case) 24, which walk in the opposite direction of the animal stirring device 10. Thus, the animals 24 no longer stay grouped, stationary, and greater access is granted to hungry animals 24.

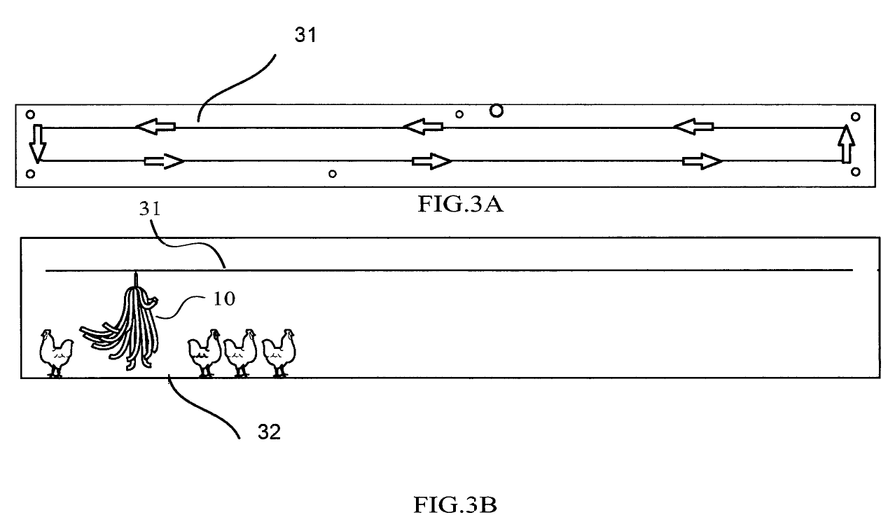

FIG. 3A illustrates a top view of the arrangement of an automated delivery system 31 which is a delivery system known in the art and is being used in conjunction with the animal stirring device 10 of the present invention. The automated delivery system 31 goes round the CAFO. The arrows show the exact direction in which the animal stirring device 10 will be travelling around the CAFO when attached to the automated delivery system 31.

FIG. 3B illustrates how the animal stirring device 10 of the present invention will be travelling after being mounted to the automated delivery system 31 using the mounting device 20, dispersing the animals 24 which once again will move in the opposite direction of the animal stirring device 10. The height 32 of the device 10 from the ground can always be adjusted for better results.

Additionally, other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “attached”, “joined” are to be construed as partly or wholly contained within, attached to, or joined together, even if there is something intervening. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An animal stirring device, comprising:
a plurality of strips of light weight heavy duty durable material;
a hoop to join together each end of said plurality of strips, said hoop enabling said plurality of strips to flow outward; and
a mounting device attached to a top exterior surface of said hoop;
wherein said animal stirring device mounted to a pole using said mounting device enables said plurality of strips to pivot around while flowing outward from said hoops and move in all direction in presence of air movement making said animal stirring device look voluminous and large in size for stirring one or more animals.

2. The animal stirring device as in claim 1, wherein said plurality of strips are long enough for making said animal stirring device look like an animal larger than or equal to an average poultry.

3. The animal stirring device as in claim 1, wherein a height of said animal stirring device above ground is varied using said pole.

4. (canceled)

5. (canceled)

6. The animal stirring device as in claim 1, wherein said delivery system is an automated conveyance system.
